(19) United States
(12) Patent Application Publication
(10) Pub. No.: US 2024/0066485 A1
(43) Pub. Date: Feb. 29, 2024

(54) FILM REACTOR FOR A GAS-LIQUID, IN PARTICULAR A SULFONATION, OR SULFATATION, REACTION

(71) Applicant: DESMET BALLESTRA S.P.A., Milano (IT)

(72) Inventors: Fabrizio NAVA, Milano (IT); Ilio SEBASTIANI, Milano (IT); Icilio ADAMI, Milano (IT); Antonino MILICIA, Milano (IT); Rocco Alessandro DI BENEDETTO, Milano (IT); Federico Piero GHIONI, Milano (IT); Loris PELI, Milano (IT)

(21) Appl. No.: 18/259,631

(22) PCT Filed: Dec. 23, 2021
(86) PCT No.: PCT/IB2021/062241

§ 371 Date: Jun. 28, 2023

(30) Foreign Application Priority Data
Dec. 29, 2020 (IT) 102020000032612

(51) Int. Cl. B01J 4/00; B01J 4/02; B01J 10/02; B01J 19/00; B01J 19/24; C01B 17/80

(52) U.S. Cl. CPC B01J 4/002; B01J 4/02; B01J 10/02; B01J 19/0013; B01J 19/006; B01J 19/248; C01B 17/80; B01J 2204/002; B01J 2219/00763

(57) ABSTRACT

A continuous falling film reactor includes a reactor body including chambers for a reaction between first and second reagents. The chambers have a respective inner surface, for the sliding of the first reagent in the form of a thin film, or layer, a device for introducing the first reagent, in particular in the liquid phase, especially in the form of an organic raw material, into the respective chamber and a device for inputting the second reagent, in particular in the gaseous phase, especially in the form of sulphuric anhydride, in the respective one of the chambers. A head introduces the first reagent, in the respective chamber, which head—includes a corresponding nozzle so calibrated to cause a predetermined load loss of said first reagent.

### FIELD OF APPLICATION OF THE PRESENT INVENTION

The present invention relates to a continuous falling film reactor to obtain a product through a gas-liquid, in particular a sulfonation, or sulfatation, reaction.

Preferably, the product obtained through the present reactor is a surfactant, in particular a surfactant of the anionic type.

In particular, the reaction, in particular the sulfonation or sulfatation reaction, occurs between a first reagent, in particular in the liquid phase, especially in the form of an organic raw material, and a second reagent, in particular in the gaseous phase, especially in the form of sulphuric anhydride, i.e., diluted sulphuric anhydride, preferably diluted with air.

### STATE OF THE ART

Reactors to obtain a corresponding surfactant of the anionic type, through a continuous, rapid, and exothermic sulfonation, or sulfatation, reaction between a first reagent in the liquid phase, i.e., in the form of an organic raw material, and a second reagent in the gaseous phase, i.e., in the form of sulphuric anhydride, in particular diluted with air, are known.

Said already-known sulfonation, or sulfatation, reactors comprise a reactor body, or outer shell, in particular elongated and vertical, which is adapted to house a plurality of chambers, in particular elongated and/or tubular reaction chambers, in particular falling reaction chambers, between said first reagent and said second reagent, as well as means for the introduction of said first reagent, or organic raw material, and means for inputting said second reagent, or sulphuric anhydride, into the respective one of said reaction chambers.

A felt problem related to these already-known reactors is an imperfect distribution of said second reagent, or sulphuric anhydride, inside said reaction chambers. This causes the known reactors not being able to obtain an efficient control of the process and such as to limit the occurrence of side reactions, i.e., such as to ensure a high qualitative uniformity, and with the further drawback that frequent maintenance interventions are required, resulting in a shorter duration of the reactor production cycles.

In fact, in said already-known reactors, the presence of deposits of carbonaceous material inside the respective reaction chamber is excessive, and, in order to remove them, it is necessary to resort to frequent and relevant cleaning interventions of the same chamber.

A further felt problem related to these already-known reactors is the non-homogeneous and even distribution of said first reagent, or organic raw material in the liquid phase, between the reaction chambers and on the inner surface of the respective reaction chamber, and this also is such as not to obtain an efficient control of the process, such as to limit the occurrence of side reactions and the achievement of a high qualitative uniformity and such as to make the presence of deposits of carbonaceous material inside the respective reaction chamber excessive, thus requiring to resort to frequent and relevant cleaning interventions for the same chamber, and consequent reduced duration of the production campaigns of these already-known reactors.

Furthermore, another felt problem related to these already-known reactors is the uneven distribution of the cooling liquid flow into said reactor body, or outer shell, with the result that some reaction chambers are not sufficiently and/or homogeneously cooled with respect to other chambers of the reactor. Ultimately, this also causes a lesser reaction efficiency and a shorter duration of the production cycles of the reactor.

In any case, industrially, a need is strongly felt to make products, in particular surfactant products, which are of high quality.

### SUMMARY OF THE INVENTION

Therefore, the present invention aims to propose a solution that is new and alternative with respect to the solutions known so far, and in particular it is aimed to obviate one or more of the drawbacks or problems set forth above and/or to meet one or more needs set forth above, and/or anyhow felt in the art, and in particular deducible from the above.

Thus, a continuous falling film reactor is provided, to obtain a product through a gas-liquid, in particular a sulfonation, or sulfatation, reaction, between a first reagent, in particular in the liquid phase, especially in the form of an organic raw material, and a second reagent, in particular in the gaseous phase, especially in the form of sulphuric anhydride, i.e., of diluted sulphuric anhydride, preferably diluted with air; the reactor comprising a reactor body, or outer shell, adapted to house a plurality of chambers, in particular elongated and/or tubular chambers, for a reaction between said first reagent and said second reagent; said chambers, in particular elongated and/or tubular reaction chambers having a respective inner surface, in particular for the sliding of said first reagent in the form of a thin film, or layer, means for the introduction of said first reagent, in particular in the liquid phase, especially in the form of an organic raw material, into said chambers, in particular elongated and/or tubular, reaction chambers, and means for inputting said second reagent, in particular in the gaseous phase, especially in the form of sulphuric anhydride, in the respective, in particular elongated and/or tubular, reaction chamber; means, or a head, being provided for the introduction of said first reagent, in particular in the liquid phase, especially in the form of an organic raw material, in the respective, in particular elongated and/or tubular, reaction chamber; characterized in that said means, or head, for the introduction of said first reagent, in particular in the liquid phase, especially in the form of an organic raw material, in the respective, in particular elongated and/or tubular, reaction chamber, comprise, or comprises, corresponding nozzle means, in particular, radially extending nozzle means, for the passage of said first reagent, or organic raw material, in particular a fluid, preferably liquid raw material, towards the respective, in particular elongated and/or tubular, reaction chamber; and in that said nozzle means are in the form of said nozzle means calibrated so as to cause a predetermined load loss of said first reagent, in particular in the liquid phase, especially in the form of an organic raw material, feeding towards the respective, in particular elongated and/or tubular, reaction chamber, such as to ensure a controlled, in particular a constant or substantially constant, flow rate, of said first reagent, in particular in the liquid phase, especially in the form of an organic raw material, entering the respective, in particular elongated and/or tubular, reaction chamber, and so as to evenly distribute said first reagent, in particular in the liquid phase, especially in the form of an organic raw material, on the respective inner surface thereof.

In this manner, a homogeneous and even distribution of said first reagent, in particular in the liquid phase, on the inner surface of the respective reaction chamber is ensured.

Therefore, a more efficient reaction is obtained, hence the presence of deposits of carbonaceous material inside the respective reaction chamber is reduced, and therefore the need to carry out periodical cleaning interventions for the same chamber is consequently reduced.

Ultimately, the service life of the same reactor in a condition of high efficiency is extended.

Furthermore, in this manner, a product is made, i.e., a surfactant product, in particular a surfactant of the anionic type, the quality of which is particularly high.

### BRIEF DESCRIPTION OF THE DRAWINGS

This and other innovative aspects, or respective advantageous embodiments are anyhow set forth in the attached claims, the specific technical features of which can be found, together with corresponding advantages achieved, in the following description, illustrating in detail a merely exemplary, non-limiting embodiment of the invention, and which is made with reference to the attached drawings, in which:

FIG. 1 illustrates a vertical section, schematic view of a preferred embodiment of reactor according to the present invention;

FIG. 2 illustrates a schematic, cutout perspective view of the upper part of the preferred embodiment of reactor according to the present invention;

FIG. 3 illustrates a schematic side elevation view of the preferred embodiment of means for inputting said second reagent, which is used in the reactor according to the present invention;

FIG. 4A illustrates a vertical section, schematic view of a preferred embodiment of means, or head, for the introduction of said first reagent, in particular in the liquid phase, especially in the form of an organic raw material, in the respective one of said chambers, in particular elongated and/or tubular, reaction chambers, which are used in the reactor according to the present invention;

FIG. 4B illustrates a schematic side elevation view of a preferred embodiment of the outer body composing the means, or head, for the introduction of said first reagent;

FIG. 4C illustrates a vertical section, schematic view of the preferred embodiment of the outer body composing the means, or head, for the introduction of said first reagent;

FIG. 4D illustrates a vertical section, schematic view of a preferred embodiment of the inner body composing the means, or head, for the introduction of said first reagent;

FIG. 4E illustrates a vertical section, schematic view of a preferred embodiment of a thickness member to adjust the fitting positioning between said first and second bodies composing the respective means, or head, for the introduction of said first reagent;

FIG. 5 illustrates a perspective schematic view of a preferred embodiment of means for the distribution of said first reagent, between said chambers, in particular elongated and/or tubular, reaction chambers, which are used in the reactor according to the present invention;

FIG. 6 illustrates a longitudinal section, schematic view of a first preferred embodiment of means for cooling said reaction chambers, or tubes, which are used in the reactor according to the present invention;

FIG. 7A illustrates a longitudinal section, schematic view of a second preferred embodiment of means for cooling said reaction chambers, or tubes, which are used in the reactor according to the present invention;

FIG. 7B illustrates a transversal section, schematic view of the second preferred embodiment of means for cooling said reaction chambers, or tubes, which are used in the reactor according to the present invention;

FIG. 7C illustrates a vertical section, schematic view of a detail of the second which are used of means for cooling said reaction chambers, or tubes, which are used in the reactor according to the present invention;

FIG. 7D illustrates a schematic elevation front view of a planar member that is adapted to homogeneously distribute the transversal flow of the cooling fluid, or liquid, used in the second preferred embodiment of means for cooling said reaction chambers, or tubes, which are used in the reactor according to the present invention;

FIG. 7E illustrates an enlarged schematic view of a detail of said planar member of FIG. 7D, in particular illustrating respective openings for the passage of the cooling fluid or liquid.

### DETAILED DESCRIPTION OF PREFERRED EMBODIMENTS OF THE INVENTION

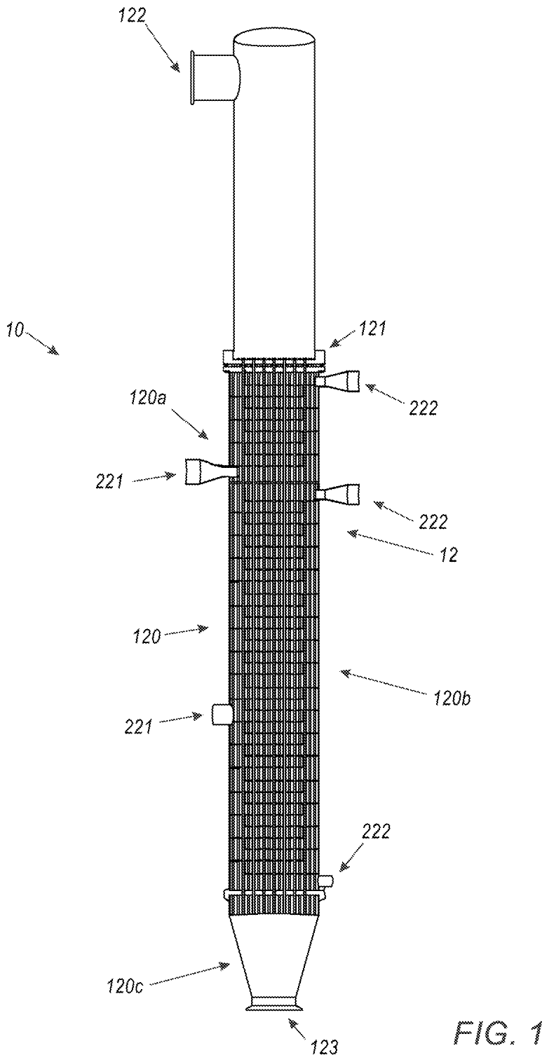

In the attached FIGS. 1 to 7E, a preferred embodiment is illustrated of a continuous falling film reactor adapted to obtain a product through a gas-liquid, in particular a sulfonation, or sulfatation, reaction, between a first reagent, in particular in the liquid phase, especially in the form of an organic raw material, for example selected between alkyl benzenes, linear or branched alkenes, low and high molecular weight alcohols, low and high molecular weight alkoxylated in particular ethoxylated and propoxylated, esters, aromatic compounds, fatty acids, glycerides (mono-, di- and triglycerides), or other families, and a second reagent, in particular in the gaseous phase, especially in the form of sulphuric anhydride, i.e., of diluted sulphuric anhydride, preferably diluted with air.

As it is clear in particular from FIG. 1, the present reactor comprises a reactor body, or outer shell, 12, in particular having an elongated shape and vertically extending, which reactor has suitable means 121 for inputting said first reagent into the reactor, suitable means for inputting said second reagent 122 into the reactor, and means 123 for outletting product from the reactor, in particular for outletting the surfactant product.

As it is clear from said figures, said reactor body, or outer shell, 12 preferably has a circular outer profile and is adapted to house a plurality of chambers, in particular elongated and/or tubular reaction chambers 14, in particular for a falling continuous reaction, between said first reagent and said second reagent.

As it is clear from the figures, said chambers, in particular elongated and/or tubular reaction chambers 14, have a respective inner surface 140, in particular for the sliding of said first reagent in the form of a thin film, or layer, and a respective outlet, especially confluent in said outlet, in particular lower outlet, 123 of said reactor body, or outer shell, 12.

Furthermore, preferably said chambers, in particular elongated and/or tubular reaction chambers 14 are vertically extended and transversally ordered, or arranged, according to a quincuncial arrangement, i.e., in which respective rows 141 of chambers are spaced apart, in particular equally spaced apart from one another, and in which the respective camera 14 is perpendicularly offset with respect to the adjacent chambers of the adjacent row, in particular in an equi distanced manner from the same adjacent chambers.

In particular, as it is clear from said figures, the reactor 10 comprises means 16 for the introduction of said first reagent, in particular in the liquid phase, especially in the form of an organic raw material, into the respective, in particular elongated and/or tubular, reaction chamber 14.

Furthermore, as it is clear from the same figures, the reactor 10 comprises means 18 for inputting said second reagent, in particular in the gaseous phase, especially in the form of sulphuric anhydride, in the respective, in particular elongated and/or tubular, reaction chamber 14.

Advantageously, as illustrated, that said means 18 for inputting said second reagent, in particular in the gaseous phase, especially in the form of sulphuric anhydride, are configured so as to supply to said plurality of reaction chambers, or tubes, 14 an even, or substantially even, gas flow, i.e., an even, or substantially even, gas flow for the whole plurality of, i.e., for all, said reaction chambers, or tubes, 14 of the reactor.

According to another point of view, in other words, said means 18 for inputting said second reagent, in particular in the gaseous phase, especially in the form of sulphuric anhydride, are configured so as to supply to said plurality of reaction chambers, or tubes, 14 a gas flow having an even advancement rate, i.e., a gas flow having an even advancement rate for the whole plurality of, i.e., for all, said chambers, or tubes.

In practice, in this manner, it is possible to obtain a more efficient reaction and thus to reduce the presence of deposits of carbonaceous material inside the respective reaction chamber 14 hence to decrease the need to carry out periodical cleaning interventions for the same reaction chambers, with a consequent extension of the service life of the same reactor in a condition of high efficiency.

Furthermore, in this manner a product is obtained, i.e., a surfactant product, in particular a surfactant of the anionic type, the quality of which is particularly high.

In an advantageous manner, as it is very clear from FIG. 1, said reactor body, or outer shell, 12 has a peripheral, in particular circumferential, outer wall, 120, especially, as illustrated, defined by corresponding longitudinal wall sections 120a, 120b, 120c that are connected to one another at the respective longitudinal ends.

In particular, the peripheral outer wall of said reactor body, or outer shell, 12 ends in an outlet section 120c, in particular defined by a conical wall that is located downstream, i.e., inferiorly, to said main and intermediate part 120b of the circumferential outer wall 120, and which conveys said obtained product, or surfactant, towards the outlet mouth 123.

As it is clear from said FIGS. 1 to 3, with advantage, said means 18 for inputting said second reagent, in particular in the gaseous phase, especially in the form of sulphuric anhydride, are supported by said reactor body, or outer shell, 12, i.e., by the respective peripheral outer, in particular circumferential, wall, 120, thereof, especially at the respective upstream, in particular upper, end thereof.

As it is clear from said FIGS. 1 to 3, in a particularly advantageous manner, said means 18 for inputting the second reagent, in particular in the form of a gaseous reagent, preferably in the form of sulphuric anhydride, in the same chambers, in particular elongated and/or tubular reaction chambers 14, comprise a tubular, in particular cylindrical, conduit, 181, which extends according to a respective longitudinal axis L, in particular coaxial to the longitudinal axis of the main body 120a, 120b, 120c of the reactor, and which directly supplies the same second reagent in inlet into said reaction chambers 14.

As illustrated, said tubular, in particular cylindric, conduit, 181 for inputting the second reagent, in particular in the form of a gaseous reagent, preferably in the form of sulphuric anhydride, in the same reaction chambers 14, has an inner, especially smooth, preferably cylindrical tubular, surface, 181xa, which extends according to said longitudinal axis L, which is parallel to the axis of the respective chambers, in particular elongated and/or tubular reaction chambers 14.

As illustrated, said tubular, in particular cylindric, conduit, 181 extends between an upstream, or upper, end, 182 and a downstream, or lower, open end 183, for the inlet into said reactor body, or outer shell, 12.

As illustrated, said tubular, in particular cylindric, conduit, 181 for inputting the second reagent, in particular in the form of a gaseous reagent, preferably in the form of sulphuric anhydride, in the same reaction chambers 14, opens at a zone, or plane, 162, at which the openings 149 for inputting the respective gas flow into the corresponding reaction chambers 14 are provided.

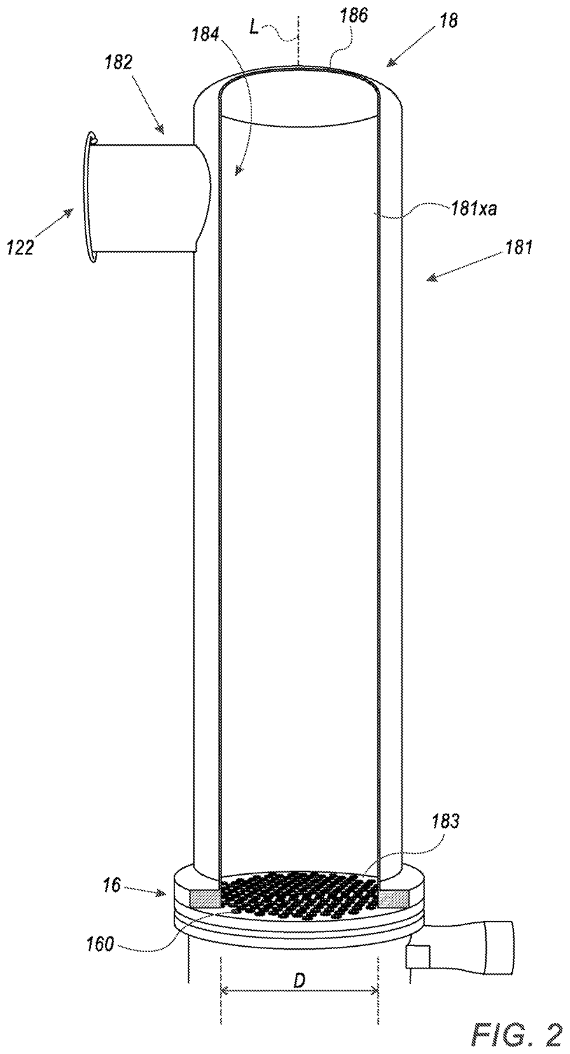

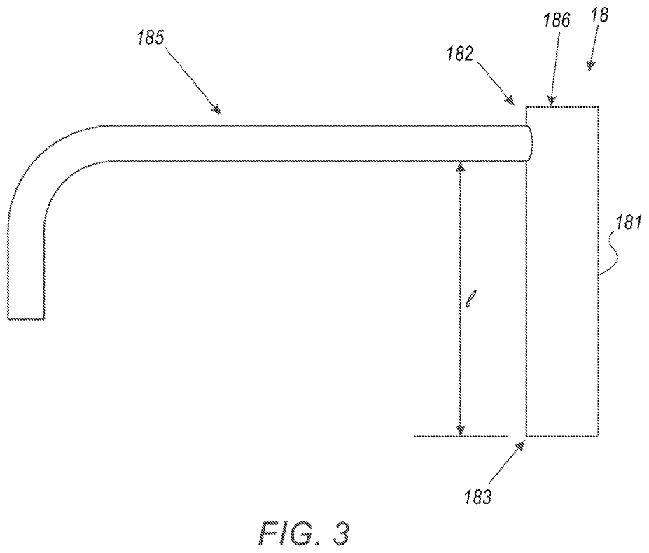

As it is clear from said FIGS. 2 and 3, advantageously, said means 18 for inputting the second reagent, in particular in the form of a gaseous reagent, preferably in the form of sulphuric anhydride, in the same reaction chambers, or tubes, comprise a mouth 184 for the inlet of said second reagent, in particular at an upstream, or upper, end, 182 of said tubular, in particular cylindrical, conduit, 181, and in particular provided at the side wall of the same tubular, in particular cylindric, conduit, 181, and an outlet mouth 183, in particular lying in a plane that is perpendicular, or transversal, to said longitudinal axis L of the same tubular conduit 181.

As illustrated, said tubular, in particular cylindric, conduit, 181 for inputting the second reagent has a closing, in particular an outermost upper closing wall, 186, provided on the side of the same tubular, in particular cylindric, conduit, 181, which is opposite the side for the connection to the peripheral, in particular circumferential, outer wall 120, of the reactor body.

As it is clear from said figures, and in particular from FIG. 3, said second reagent comes especially from a respective adduction conduit 185, in particular perpendicularly elongated with respect to said tubular, in particular cylindric, conduit, 181.

As illustrated, furthermore, said tubular, in particular cylindric, conduit, 181, i.e., the corresponding cylindrical inner surface thereof, has a respective diameter “D”.

As it is clear from said FIGS. 1 to 3, in an advantageous and particularly preferred manner, said means 18 for inputting said second reagent, in particular in the gaseous phase, especially in the form of sulphuric anhydride, i.e., said tubular, in particular cylindric, conduit, 181, have, or has, a longitudinal length, “1”, especially comprised between said inlet mouth 184, i.e., between the lower edge thereof, and said outlet mouth 183 of said tubular conduit 181, which longitudinal length, “1” is greater than the extension of the corresponding diameter “D” of said means 18 for inputting said second reagent, i.e., of said tubular conduit 181, which in particular is greater than 2-folds the extension of said diameter “D”, preferably which is greater than 3-4-folds the extension of said diameter “D”, and, in an even more preferred manner, being greater than 5-folds the extension of the same diameter “D”.

According to an alternative form, not illustrated in the attached figures, it would also be imaginable to obtain an even, or substantially even, gas supply, i.e., a gas supply with a positive advancement rate, for the whole plurality of, i.e., for all, said chambers, or tubes, through corresponding diverting members, or septa, to be positioned in said means 18 for inputting said second reagent, in particular in the gaseous phase, upstream the inlet into the same reaction chambers, or tubes 14.

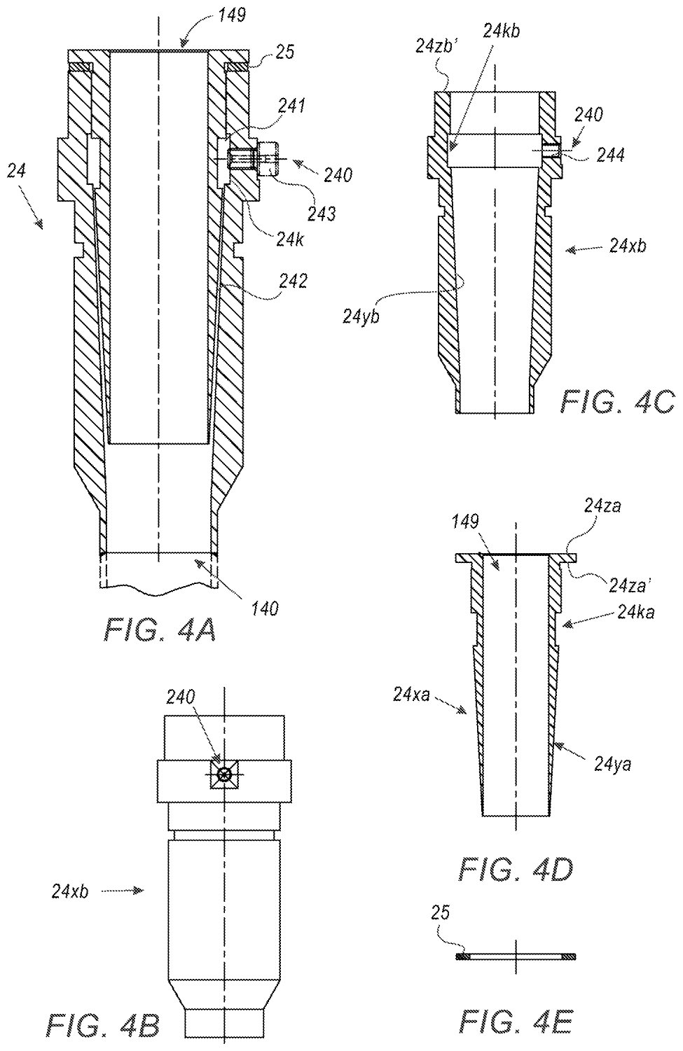

As it is clear from the subsequent FIGS. 4A to 4E, according to another advantageous aspect, means, or head, 24 are provided for the introduction of said first reagent, in particular in the liquid phase, especially in the form of an organic raw material, in the respective, in particular elongated and/or tubular, reaction chamber 14.

As it is clear from said FIGS. 4A to 4E, advantageously, said means, or head, 24 for the introduction of said first reagent, in particular in the liquid phase, especially in the form of an organic raw material, in the respective, in particular elongated and/or tubular, reaction chamber 14, comprise corresponding nozzle means 240, in particular, radially extending nozzle means, for the passage of said first reagent, or organic raw material, in particular a fluid, preferably liquid raw material, towards the respective, in particular elongated and/or tubular, reaction chamber 14.

As it is clear from said FIGS. 4A to 4E, in a particularly advantageous manner, said nozzle means 240 are in the form of said nozzle means calibrated so as to cause a predetermined load loss of said first reagent, in particular in the liquid phase, especially in the form of an organic raw material, feeding towards the respective reaction chamber 14, and such as to ensure a controlled, in particular a constant or substantially constant, flow rate, of said first reagent entering the respective, reaction chamber 14.

In this manner, a homogeneous distribution of said first reagent, in particular in the liquid phase, especially in the form of an organic raw material, on the respective inner surface 140 of the respective reaction chamber 14 is ensured.

Therefore, a more efficient reaction is obtained, and thus the presence of deposits of carbonaceous material inside the respective reaction chamber is reduced, and the need to carry out periodical cleaning interventions for the same chamber is consequently reduced.

Ultimately, the service life of the same reactor in a condition of high efficiency is extended.

Furthermore, in this manner, a product is made, i.e., a surfactant product, in particular a surfactant of the anionic type, the quality of which is particularly high.

As it is clear from said FIGS. 4A to 4E, advantageously, said nozzle means 240 impart to said first reagent, in particular in the liquid phase, especially in the form of an organic raw material, a load loss above 5000 Pa, preferably above 10000 Pa, and more preferably above 20000 Pa.

As it is clear from said FIGS. 4A to 4E, with advantage, said nozzle means, for the passage of said first reagent, or organic raw material, in particular a fluid, preferably liquid raw material, towards the respective, in particular elongated and/or tubular, reaction chamber 14, comprise a single calibrated passage nozzle 240, which is obtained in said means, or head, 24 for the introduction of said first reagent, in particular in the liquid phase, especially in the form of an organic raw material, in the respective, in particular elongated and/or tubular, reaction chamber 14.

Said calibrated passage nozzle means, or single nozzle, 240, obtained in said means, or heads, 24 for the introduction of said first reagent, in particular in the liquid phase, especially in the form of an organic raw material, in the respective, in particular elongated and/or tubular, reaction chamber 14, extend, or extends, in particular radially, between an outer face, or surface, and an inner face, or surface of the same means, or head, 24 for the introduction of said first reagent into the respective reaction chamber 14.

In a preferred, anyhow optional, manner, said calibrated passage nozzle means, or single nozzle, 240, obtained in said means, or heads, 24 for the introduction of said first reagent lie, or lies, in a corresponding plane perpendicular, or transversal, to the respective longitudinal axis of the same means, or head, 24 for the introduction of said first reagent, i.e., the respective reaction chamber 14.

With advantage, as it is clear from said FIGS. 4A to 4E, the calibrated passage nozzle, in particular the single calibrated passage nozzle 240 has a respective diameter that ranges between 0.1 mm and 5 mm, and that preferably ranges between 1.2 mm and 1.6 mm.

As it is clear from said FIGS. 4A to 4E, advantageously, the calibrated passage nozzle, in particular the single calibrated passage nozzle 240 has a length that ranges between 1 mm and 30 mm and preferably that ranges between 7 mm and 10 mm.

As it is clear from said FIGS. 4A to 4E, advantageously, said means, or head, 24 for the introduction of said first reagent, in particular in the liquid phase, especially in the form of an organic raw material, in the respective, in particular elongated and/or tubular, reaction chamber 14, comprise an annular, in particular circumferential, cavity, 241 for the peripheral diffusion of said first reagent, in particular in the liquid phase, especially in the form of an organic raw material, which annular, in particular circumferential, cavity, 241 for the peripheral diffusion of said first reagent, in particular in the liquid phase, especially in the form of an organic raw material, is in communication with the inside of the respective reaction chamber 14, through an annular conduit 242, that is longitudinally extending and coaxial with the respective reaction chamber 14, and in particular, as illustrated, radially converging towards and into the respective reaction chamber 14, opening at the inner surface 140 of the respective reaction chamber 14.

In an advantageous manner, as it is clear from said FIGS. 4A to 4E, said annular conduit 242 and/or said annular, in particular circumferential, cavity, 241, for the peripheral diffusion of said first reagent, in particular in the liquid phase, especially in the form of an organic raw material, are defined between a first and a second bodies 24xa, 24xb, in particular tubular, which are coaxially coupled one inside the other, in particular in a male-female relation.

In particular, as it is clear from said FIGS. 4A to 4E, said annular conduit 242 is defined between the outer surface 24ya of the lower part of said inner body 24xa and the inner surface 24yb of the lower part of said outer body 24xb of the head.

As illustrated in FIG. 4A, said first body, or male body, 24xa is in connection and coaxial with the respective, in particular elongated and/or tubular, reaction chamber 14 and being internally hollow, in particular tubular, to convey said second reagent downstream, in particular in the form of a gaseous reagent, preferably in the form of sulphuric anhydride, into the respective, in particular elongated and/or tubular, reaction chamber 14.

Advantageously, it is provided for that said annular conduit 242 has a circumferentially even configuration, and in particular a thickness of the passage, in particular according to a radial direction, that is less than 2 mm, in particular that is less than 1 mm, and in a particularly advantageous manner that ranges between 0.1 mm and 0.5 mm.

In this manner, advantageous means are defined, which are able to circumferentially, homogeneously distribute, along the same annular conduit 242, the flow of the first reagent, in particular in the liquid phase, especially in the form of an organic raw material, feeding towards the respective reaction chamber.

In particular, it is intended that, while being preferred that the same annular conduit 242 has a general conical configuration, as illustrated, it can be also conceived that the same annular conduit 242 is made in a cylindrical configuration.

As it is clear from said FIGS. 4A to 4E, the present head 24 can comprise an annular member 25, with a predetermined thickness, which is adapted to be interposed between the transversal annular surface 24za′ of a shoulder 24za, radially projecting externally to said inner body 24xa, located at the end, upper in use, of the same inner body 24xa, and an outermost annular surface 24zb′, upper in use, of said outer body 24xb.

As it is clear from said figures, said calibrated nozzle 240 is defined by a corresponding screw 243 that screws in a corresponding hole, in particular a radial hole, 244 of said outer body 24xb, which screw 243 has a corresponding axial through hole 240, defining said calibrated nozzle.

As it is clear from the figures, said annular, in particular circumferential, perimetral spreading cavity, 241 is defined between corresponding annular grooves 24ka and 24kb, which are provided, i.e., obtained, at the respective outer surface 24ya of said inner body 24xa and the inner surface 24yb of said outer body 24xb.

As it is clear, said calibrated nozzle 240, i.e., the corresponding hole 244 for housing said screw 243 having said nozzle 240, opens at said recessed annular surface 24kb of said outer body, i.e., in use, at said annular cavity 241.

In particular as illustrated, said first body, or male body, 24xa defines said opening 149 for inletting the respective flow of reagent gas, preferably in the form of sulphuric anhydride, into the respective, in particular elongated and/or tubular, reaction chamber 14.

As it is clear from said FIGS. 4A to 4E, said nozzle means, or said calibrated passage nozzle, 240 are provided, or is provided, in said second body, or female body, 24xb of the means, or head, 24 for the introduction of said first reagent.

Advantageously, as it is clear from said FIGS. 1, 2, and 5, said means 16 for the introduction of said first reagent, in particular in the liquid phase, especially in the form of an organic raw material, into said chambers, in particular elongated and/or tubular reaction chambers 14, comprise means 161 for the distribution of said first reagent, in particular in the liquid phase, especially in the form of an organic raw material, between said reaction chambers 14.

In a particularly advantageous manner, as it is clear from said FIGS. 1, 2, and 5, said means 161 for the distribution of said first reagent, in particular in the liquid phase, especially in the form of an organic raw material, between said reaction chambers 14, are adapted to supply said first reagent to said inlet means, or nozzle means, 240 of the respective reaction chamber 14.

Advantageously, as it is clear from said FIGS. 1, 2, and 5, said means 161 for the distribution of said first reagent, in particular in the liquid phase, especially in the form of an organic raw material, between said chambers, in particular elongated and/or tubular reaction chambers 14 comprise a plane, in particular horizontal, preferably having a circular outer profile, 162 for conveying said first reagent, in particular in the liquid phase, especially in the form of an organic raw material, towards said inlet means, or nozzle means, 240 of the respective, in particular elongated and/or tubular, reaction chamber 14.

In a particularly advantageous manner, as it is clear from said FIGS. 1, 2, and 5, means 163 are provided for the supplying of said first reagent, in particular in the liquid phase, especially in the form of an organic raw material, to said conveying plane 162 of said first reagent towards said inlet means, or nozzle means, 240 of the respective reaction chamber 14.

As it is clear from said FIGS. 1, 2, and 5, with advantage, said means 163 for the supplying of said first reagent, in particular in the liquid phase, especially in the form of an organic raw material, to said conveying plane 162, extend peripherally outwards to said plane 162 for conveying said first reagent towards said inlet means, or nozzle means, 240 of the respective reaction chamber 14.

In this manner, a homogeneous and even distribution of said first reagent to all the reaction chambers is ensured, which allows to get an efficient reaction for all the reaction chambers of the reactor.

In this manner, the reactor makes a product, i.e., a surfactant product, in particular a surfactant of the anionic type, the quality of which is particularly high.

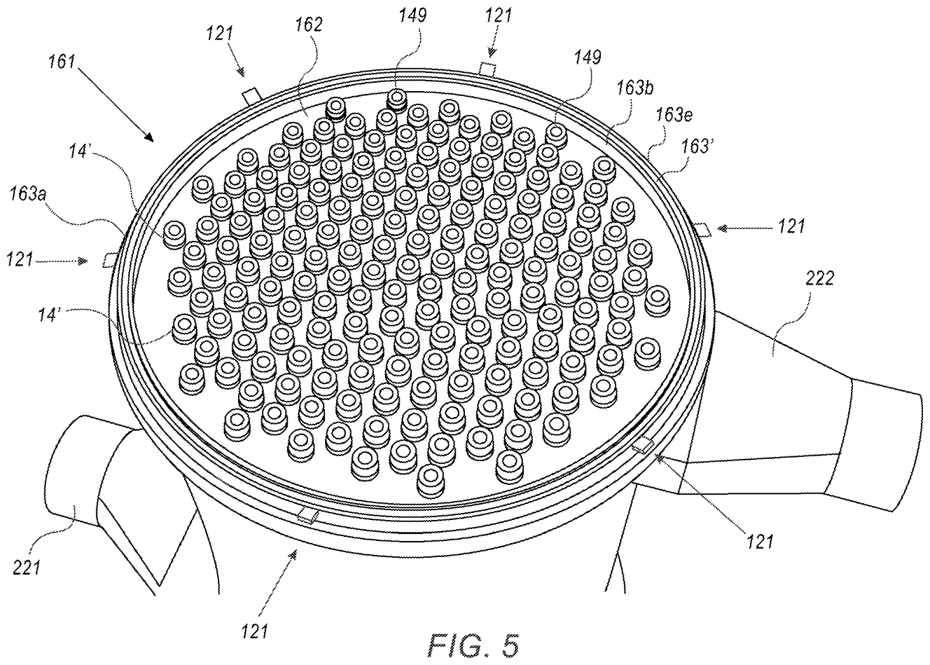

Advantageously, as it is clear from said FIGS. 2 and 5, said means 163 for the peripheral supplying of said first reagent, in particular in the liquid phase, especially in the form of an organic raw material, to said conveying plane 162 comprise a peripheral channel 163′, in particular external to said conveying plane 162, and inside which said first reagent spreads and from which it peripherally opens to said conveying plane 162 of said first reagent towards said inlet means, or nozzle means, 240 of the respective reaction chamber 14.

Advantageously, as it is clear from said FIGS. 2 and 5, said peripheral supplying channel 163′, in particular external to said conveying plane 162, and preferably circular, comprises a bottom surface 163a, in particular horizontal, especially extending with a circular profile.

As it is clear from said FIGS. 2 and 5, said peripheral supplying channel 163′, in particular external to said conveying plane 162, and preferably circular, comprises a respective side surface 163b, in particular circular, preferably perpendicular to said conveying plane 162 of said first reagent and opening, or overflowing, thereinto, and especially extending vertically, or perpendicularly, to said bottom surface 163a, on the radially inner side thereof.

With advantage, as it is clear from said FIGS. 2 and 5, said peripheral supplying channel 163′, in particular external to said conveying plane 162, and preferably circular, comprises a respective side surface 163c, in particular circular, especially extending vertically, or perpendicularly, to said bottom surface 163a, on the radially outer side thereof, i.e., on the side that is radially opposite the one of said side surface 163b opening on said conveying plane 162.

Noticeably, as it is clear from said FIGS. 2 and 5, said plane 162 for conveying said first reagent is arranged at a height level that is above the bottom surface 163a of said peripheral channel 163′.

However, according to a different embodiment, not illustrated in the attached figures, it can be also conceived that said plane for conveying said first reagent is arranged at a height level below the bottom surface of said peripheral channel, which in this case could be defined, on the inner side thereof, by a corresponding plate suitably perforated and through which said first reagent reaches the same conveying plane.

As it is clear from said figures, the heads 24 have the respective upper end projecting perpendicularly from said sliding and distribution plane 162, in particular in such an extent as to arrange superiorly, or substantially at this, the corresponding nozzle means, or single nozzle, 240.

As it is clear from said FIGS. 1, 2, and 5, means 121 are provided for the inlet of said first reagent into said means 161 for the distribution of said first reagent between said chambers, in particular elongated and/or tubular reaction chambers 14, i.e., for the inlet into said peripheral channel 163′ for the supplying of said first reagent.

Advantageously, as it is clear from said FIGS. 1, 2, and 5, said means 121 for the inlet of said first reagent into said means 161 for the distribution of said first reagent between said chambers, in particular elongated and/or tubular reaction chambers 14, i.e., for the inlet into said peripheral supplying channel 163′, directly open into said peripheral supplying channel 163′.

In an advantageous manner, as it is clear from said FIGS. 1, 2, and 5, said means 121 for the inlet of said first reagent into said means 161 for the distribution of said first reagent between said chambers, in particular elongated and/or tubular reaction chambers 14, i.e., for the inlet into said peripheral supplying channel 163′, comprise a plurality of openings 121 for the inlet of said first reagent, in particular in the liquid phase, especially in the form of an organic raw material, which opening apertures 121 are angularly distributed, peripherally to said peripheral supplying channel 163′; in particular, a plurality of angularly spaced apart inlet openings 121 is provided, in particular equally spaced apart from one another.

With advantage, as it is clear from said FIGS. 2 and 5, said plane 162 for conveying said first reagent, in particular in the liquid phase, especially in the form of an organic raw material, towards said inlet means, or nozzle means, 240 of the respective reaction chamber 14, has a plurality of holes 14′ for the passage of said chambers, in particular elongated and/or tubular reaction chambers 14, i.e., for corresponding heads 24, located in the upstream zone in these reaction chambers 14.

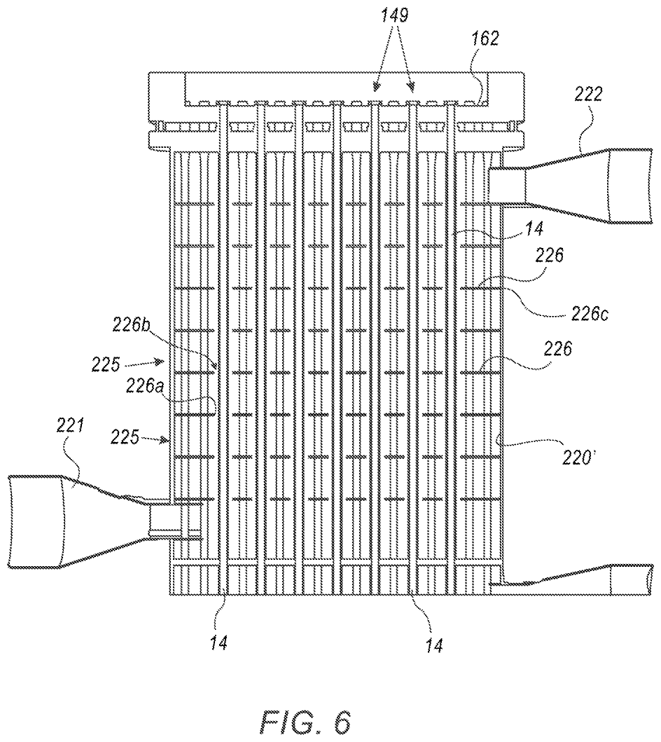

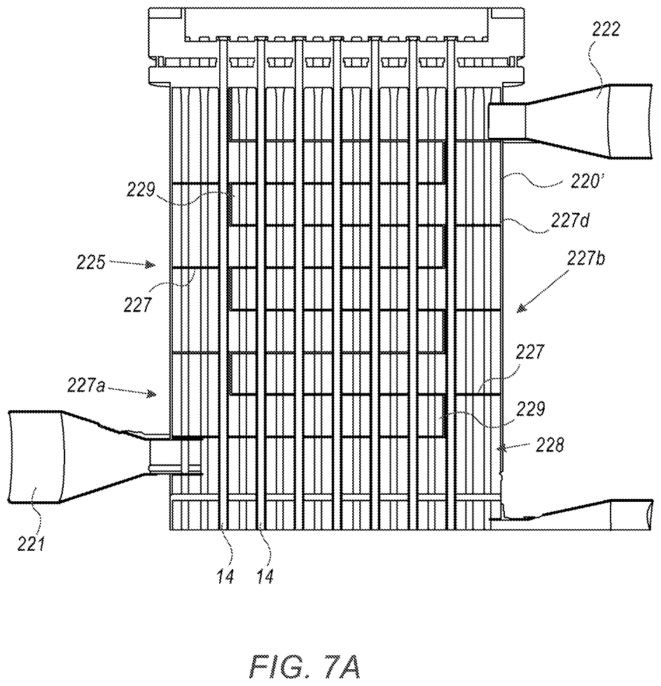

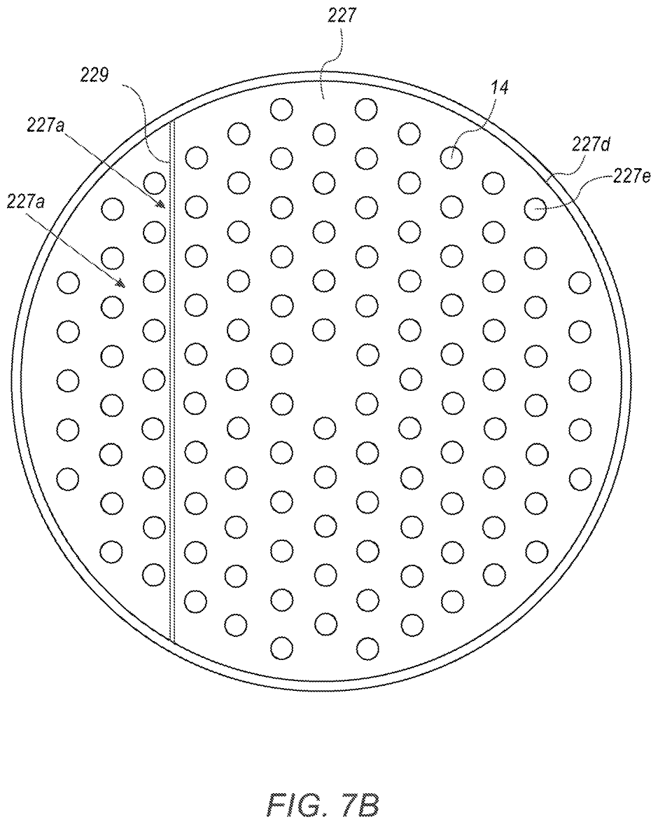

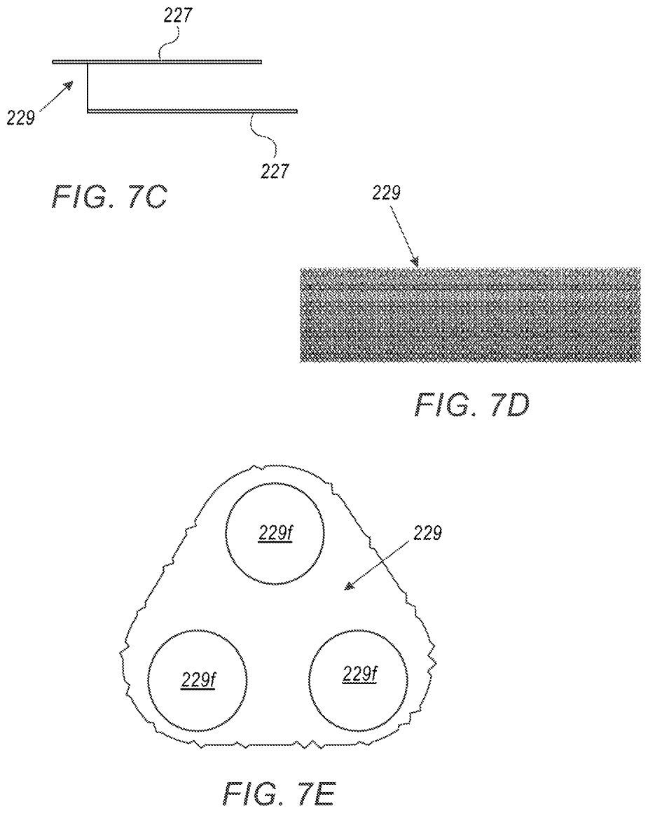

Advantageously, as it is clear from the FIGS. 6 and 7A to 7E, means 22 are provided for cooling said chambers, in particular elongated and/or tubular reaction chambers 14, which cooling means 22 use a cooling fluid, or liquid, in particular water.

Advantageously, as it is clear from said FIGS. 6 and 7A to 7E, said means 22 for cooling said chambers, in particular elongated and/or tubular reaction chambers 14 comprise, or are defined by, said reactor body, or outer shell, 12 housing said reaction chambers 14, means 221 for inputting a cooling fluid, or liquid, into the same body, or outer shell, of the reactor, 12, and means 222 for outletting the same cooling fluid, or liquid.

In particular, as illustrated in FIG. 1, a plurality of mouths 221 are provided for inputting a cooling fluid, or liquid, and a plurality of mouths 222 for outletting the same cooling fluid, or liquid.

As it is clear from FIG. 1, in an advantageous manner, said means 221 for inputting a cooling fluid, or liquid, into the same body, or outer shell, of the reactor, 12, comprise one or more mouths 221 for inputting a cooling fluid, or liquid, and/or said means 222 for outletting the same cooling fluid, or liquid, comprise one or more mouths 222 for outletting the same cooling fluid, or liquid.

In particular, as it is clear from said FIGS. 6 and 7A to 7E, the respective means, or respective mouth, 222 for outletting the same cooling fluid, or liquid, are positioned, or is positioned, at a height that is different from the respective means 221, or respective mouth, for inputting a fluid, or liquid.

Advantageously, as it is clear from said FIGS. 6 and 7A to 7E, said means 22 for cooling said reaction chambers, or tubes, 14 comprise, inside said reactor body, or outer shell, 12 for housing said reaction, in particular tubular, chambers 14, means 225 for conveying, or diverting, the flow of said cooling fluid, or liquid, in particular in the form of water, onto, or along, the outer surface of said chambers, in particular elongated and/or tubular reaction chambers 14.

In this manner, it is possible to distribute as desired said flow of said cooling fluid, or liquid, into said reactor body, or outer shell, 12 and to homogeneously cool said chambers, in particular elongated and/or tubular reaction chambers 14.

As it is clear from said FIGS. 6 and 7A to 7E, in a particularly advantageous manner, said means 225 for conveying, or diverting, the flow of said cooling fluid, or liquid, in particular in the form of water, onto, or along, the outer surface of said chambers, in particular elongated and/or tubular reaction chambers 14, comprise respective septum means 226, 227 which are adapted to convey, or divert, said flow of said cooling fluid, or liquid according to a respective predetermined or forced path.

Advantageously, as it is clear from said FIGS. 6 and 7A to 7E, said septum means 226, 227, which are adapted to convey, or divert, said flow of said cooling fluid, or liquid according to a respective predetermined path, transversally extend with respect to the extension longitudinal axis of the reactor, i.e., of said reactor body, or outer shell, 12, and/or of said chambers, in particular elongated and/or tubular reaction chambers 14.

With advantage, as it is clear from said figures, said septum means 226, 227, which are adapted to convey, or divert, said flow of said cooling fluid, or liquid according to a respective predetermined path, comprise a plurality of transversal septa 226, 227 longitudinally mutually spaced apart along said reactor body, or outer shell, 12, or along said, in particular elongated and/or tubular, reaction chambers 14.

As it is clear from said FIGS. 6 and 7A to 7E, with advantage, the septa of the respective plurality of longitudinally spaced apart septa, 226, 227, which are adapted to convey, or divert, said flow of said cooling fluid, or liquid according to a respective predetermined path, are longitudinally equally spaced from one another.

With advantage, as it is clear from said FIG. 6, in accordance with a first preferred embodiment of said means 22 for cooling said reaction chambers, or tubes, 14, said septum means, or respective plurality of longitudinally spaced apart septa, 226, which are adapted to convey, or divert, said flow of said cooling fluid, or liquid according to a respective predetermined path, are adapted to make said flow of said cooling fluid, or liquid, take a longitudinal, or predominantly longitudinal, path, in particular from bottom to top of, at least partially along, or adjacent to, the respective plurality of chambers, in particular tubular reaction chambers 14.

Advantageously, as it is clear from said FIG. 6, in accordance with the first preferred embodiment of means 22 for cooling said reaction chambers, or tubes, 14, said flow of said cooling fluid, or liquid according to a respective longitudinal, or predominantly longitudinal, path, has lengths of longitudinal flow, along, or adjacent to, the respective plurality of chambers, in particular tubular reaction chambers 14, and in particular for the passage through said septum means, or respective septum, 226, and radial expansion lengths between corresponding or adjacent septum means, or septa, 226.

As it is clear from said FIG. 6, in an advantageous manner, said septum means, or respective transversal septum, 226, which are adapted to convey, or divert, said flow of said cooling fluid, or liquid according to a respective predetermined longitudinal, or predominantly longitudinal, path, are adapted, or is adapted, to define a gap, in particular an annular gap, 226b, for the longitudinal passage of said flow of said cooling fluid, or liquid, in the neighbourhood of the respective, in particular elongated and/or tubular, reaction chamber 14.

In an advantageous manner, as it is clear from said FIG. 6, in accordance with the first preferred embodiment of said means 22 for cooling said reaction chambers, or tubes, 14, said septum means, or respective transversal septum, 226, which are adapted to convey, or divert, said flow of said cooling fluid, or liquid according to a respective predetermined path, comprise at least one corresponding hole, defined by a corresponding, preferably circular, edge, 226a, for the passing through of the respective reaction chamber 14, in particular which respective hole 226a has a corresponding diameter that is greater than the diameter of the respective reaction chamber 14 by such an extent as to define said annular gap 226b for the passage, in particular longitudinal, of said flow of said cooling fluid, or liquid.

Advantageously, as it is clear from said FIG. 6, in accordance with the first preferred embodiment of said means 22 for cooling said reaction chambers, or tubes, 14, said septum means, or respective transversal septum, 226, which are adapted to convey, or divert, said flow of said cooling fluid, or liquid according to a respective predetermined path, comprise, or are composed of a corresponding transversal panel, or wall 226 having one or more holes 226a for the passing through of the corresponding ones of said, in particular elongated and/or tubular, reaction chambers 14.

As it is clear from said FIG. 6, in a particularly advantageous manner, in accordance with the first preferred embodiment of said means 22 for cooling said reaction chambers, or tubes, 14, said septum means, or respective plurality of longitudinally spaced apart septa, 226, i.e., the respective panel 226, which are adapted, or which is adapted, to convey, or divert, said flow of said cooling fluid, or liquid according to a respective predetermined path, have, or has, a respective peripheral, or circumferential, outer edge 226c for the engagement against the peripheral, in particular circumferential, inner surface, 220′, of said reactor body, or outer shell, 12.

Advantageously, as it is clear from said FIGS. 7A to 7E, in accordance with a second preferred embodiment, said means 22 for cooling said reaction chambers, or tubes, 14, said septum means, or respective plurality of longitudinally spaced apart septa, 227, which are adapted to convey, or divert, said flow of said cooling fluid, or liquid according to a respective predetermined path, are adapted to make said flow of said cooling fluid, or liquid, take a zigzagging path, in particular from bottom to top, with said flow of said cooling fluid, or liquid moving transversally to said chambers, in particular elongated and/or tubular reaction chambers 14, between corresponding or adjacent septum means, or septa, 227, and especially in contact with the portions of said reaction chambers 14 extending between the same septum means, or septa, 227.

In a particularly advantageous manner, as it is clear in particular from FIGS. 7A to 7E, in accordance with the second preferred embodiment, said means 22 for cooling said reaction chambers, or tubes, 14, said septum means, or respective plurality of longitudinally spaced apart septa, 227, which are adapted to convey, or divert, said flow of said cooling fluid, or liquid according to a respective predetermined path, comprise corresponding means 228 for the passage, in particular in the longitudinal direction, of said flow of said cooling fluid, or liquid, through said septum means, or respective septum, 227.

Especially, said means 228 for the passage, in particular in the longitudinal direction, of said flow of said cooling fluid, or liquid, through said septum means, or respective septum, 227, being provided at, or in the proximity of, a respective transversal end 227a, 227b of the septum means, or respective septum, 227, which are adapted to convey, or divert, said flow of said cooling fluid, or liquid according to a respective predetermined path.

As it is clear in particular from FIGS. 7A to 7E, with advantage, in accordance with the second preferred embodiment of said means 22 for cooling said reaction chambers, or tubes, 14, said means 228 for the passage, in particular in the longitudinal direction, of said flow of said cooling fluid, or liquid, through said septum means, or respective septum, 227, of said septum means, or respective septa, 227, which are adjacent to one another, are provided at transversal ends 227a, 227b that are mutually opposite.

Advantageously, as it is clear from said FIGS. 7A to 7E, in accordance with the second preferred embodiment of said means 22 for cooling said reaction chambers, or tubes, 14, said septum means, or respective septum, 227, which are adapted to convey, or divert, said flow of said cooling fluid, or liquid according to a respective predetermined path, at a respective transversal end 227a, 227b, are open, i.e., have a corresponding edge, in particular a linear edge, 227c which is spaced apart from the corresponding inner surface of said reactor body, or outer shell, 12, so as to define a corresponding, in particular longitudinal, passage opening, for said flow of said cooling fluid, or liquid.

Advantageously, as it is clear from said FIGS. 7A to 7E, in accordance with the second preferred embodiment of said means 22 for cooling said reaction chambers, or tubes, 14, said septum means, or respective septum, 227, which are adapted to convey, or divert, said flow of said cooling fluid, or liquid according to a respective predetermined path, have, or has, a respective peripheral, or circumferential, outer edge 227d for the engagement against the peripheral, in particular circumferential, inner surface, 220′, of said reactor body, or outer shell, 12.

As it is clear from said FIGS. 7A to 7E, in an advantageous manner, said septum means, or respective transversal septum, 227, which are adapted to convey, or divert, said flow of said cooling fluid, or liquid according to a respective predetermined path, comprise, or are composed of a corresponding transversal panel, or wall 227 peripherally defined by a corresponding edge 227c, 227d, in particular having a circumferential length for the engagement to and sealing against said inner surface of said reactor body, or outer shell, 12 and a length, especially a rectilinear length, which is spaced apart from the same inner surface of said reactor body, or outer shell, 12 to define said opening for the passage of said flow of said cooling fluid, or liquid.

As illustrated, said panel, or transversal wall, 227 further has a plurality of holes 227e for the passing through of the corresponding ones of said, in particular elongated and/or tubular, reaction chambers 14.

With advantage, as it is clear from said FIGS. 7A to 7E, in accordance with the second preferred embodiment, at the gap provided between adjacent transversal septa 227, 227, means 229 are provided, which are adapted to evenly distribute said transversal flow of said cooling fluid, or liquid.

Advantageously, as it is clear from said FIGS. 7A to 7E, in accordance with the second preferred embodiment, said means 22 for cooling said reaction chambers, or tubes, 14, said means 229 which are adapted to evenly distribute said transversal flow of said cooling fluid, or liquid, are at a respective transversal end of said gap that is provided between adjacent transversal septa 227, 227, and/or at the respective opening 228, upstream, for the passage of said flow of said cooling fluid, or liquid, through said septum means, or respective septum, 227.

As it is clear from said figures da 7A a 7E, in a particularly advantageous manner, in accordance with the second preferred embodiment, said means 229 which are adapted to evenly distribute said transversal flow of said cooling fluid, or liquid, longitudinally extend, in particular between the corresponding adjacent transversal septa 227, 227 defining the transversal flow space of said cooling fluid, or liquid, especially engaging one of or both the corresponding opposite surfaces of said adjacent transversal septa 227, 227.

Furthermore, as it is clear from the figures, in accordance with the second preferred embodiment, said means 229 which are adapted to evenly distribute said transversal flow of said cooling fluid, or liquid, transversally extend until engaging the inner surface of the reactor body, or outer shell, 12.

Advantageously, as it is clear from said FIGS. 7A to 7E, in accordance with the second preferred embodiment, said means 229 which are adapted to evenly distribute said transversal flow of said cooling fluid, or liquid, comprise a corresponding planar member 229 having corresponding means for the opening or the passage of said flow of said cooling fluid, or liquid.

In an advantageous manner, said means 229 which are adapted to evenly distribute said transversal flow of said cooling fluid, or liquid, are defined by, or are in the form of, a porous member, a network member, a perforated plate, suitable flow conveyors, or other.

In particular, as it is clear from said FIGS. 7D and 7E, when for said means 229 that are adapted to evenly distribute said transversal flow of said cooling fluid, or liquid a perforated plate is used, corresponding holes 229f are provided in the same plate, for example in an empty/full percentage of about 58%.

As it is clear from said FIGS. 7A to 7E, with advantage, in accordance with the second preferred embodiment, said means 22 for cooling said reaction chambers, or tubes, 14, said septum means, or respective septum, 227, which are adapted to convey, or divert, said flow of said cooling fluid, or liquid according to a respective predetermined transversal, or zigzagging, path, comprise a plurality of through holes 227e for the passing through by the respective plurality of chambers, in particular elongated and/or tubular reaction chambers 14, and which through holes 227e have, or has, a respective peripheral, or circumferential, inner edge 227e for the engagement, in particular a sealed engagement, against the peripheral, in particular circumferential, outer surface of the corresponding one of said reaction chambers 14.

In accordance with a third implementation form, not illustrated in the attached figures, it can be conceived to combine the septum means, or respective plurality of longitudinally spaced apart septa, 226, of the first embodiment, which are adapted to convey, or divert, said flow of cooling fluid, or liquid, according to a longitudinal, or predominantly longitudinal, path, in particular from bottom to top of, at least partially along, or adjacent to, the respective plurality of chambers, in particular tubular reaction chambers 14, with said septum means, or respective plurality of spaced apart septa, 227, which are adapted to convey, or divert, transversally, or in a zigzagging manner, said flow of said cooling fluid, or liquid, defining a respective and desired path for the cooling flow.

Advantageously, said chambers, in particular elongated and/or tubular reaction chambers 14, are made of a corrosion-resistant material, for example in an alloy 28 or similar material.

In this manner, the service life of the reactor is considerably increased.

In practice, as it is clear, the technical features illustrated above allow, singularly or in a respective combination, to achieve one or more of the following advantageous results:
a better distribution of said second reagent, or sulphuric anhydride, inside the respective reaction chamber can be obtained, which allows to obtain a more efficient reaction;
the need for maintenance is decreased;
a longer life of the reactor is obtained;
the presence of deposits of carbonaceous material inside the respective reaction chamber is reduced;
the need to carry out periodical cleaning interventions for the same chamber is reduced;
the service life of the same reactor in a condition of high efficiency is extended;
a homogeneous and even distribution of said first reagent, in particular in the liquid phase, especially in the form of an organic raw material, on the inner surface of the respective, in particular elongated and/or tubular, reaction chamber is ensured;
it becomes possible to distribute in a desired manner said flow of said cooling fluid, or liquid, into said reactor body, or outer shell, and to homogeneously cool said chambers, in particular elongated and/or tubular, reaction chambers;
a product is made, i.e., a surfactant product, in particular a surfactant of the anionic type, the quality of which is particularly high.

The present invention is susceptible of evident industrial application. The person skilled in the art can also devise a number of modifications and/or variations to be made to the same invention, while still remaining within the scope of the inventive concept, as widely explained. Furthermore, the person skilled in the art will be able to devise further preferred implementations of the invention, which comprise one or more of the characteristics illustrated herein above of the preferred implementation set forth above, in particular as set forth in the attached claims. Furthermore, it must also be understood that all the details of the invention can be replaced by technically equivalent elements.

1-49. (canceled)

50. A continuous falling film reactor to obtain a product through a gas-liquid, in particular a sulfonation, or sulfatation, reaction, between a first reagent, in particular in the liquid phase, especially in the form of an organic raw material, and a second reagent, in particular in the gaseous phase, especially in the form of sulphuric anhydride, i.e., of diluted sulphuric anhydride, preferably diluted with air; the reactor comprising a reactor body, or outer shell, adapted to house a plurality of chambers, in particular elongated and/or tubular chambers, for a reaction between said first reagent and said second reagent; said chambers, in particular elongated and/or tubular reaction chambers having a respective inner surface, in particular for the sliding of said first reagent in the form of a thin film, or layer, introduction means of said first reagent, in particular in the liquid phase, especially in the form of an organic raw material, into said chambers, in particular elongated and/or tubular reaction chambers, and introduction means of said second reagent, in particular in the gaseous phase, especially in the form of sulphuric anhydride, in the respective, in particular elongated and/or tubular, reaction chamber; means, or head being provided for the introduction of said first reagent, in particular in the liquid phase, especially in the form of an organic raw material, in the respective, in particular elongated and/or tubular, reaction chamber; wherein said means, or head, for the inlet of said first reagent, in particular in the liquid phase, especially in the form of an organic raw material, in the respective, in particular elongated and/or tubular, reaction chamber, comprise, or comprises, corresponding nozzle means, in particular, radially extending nozzle means, for the passage of said first reagent, or organic raw material, in particular a fluid, preferably liquid raw material, towards the respective, in particular elongated and/or tubular, reaction chamber; and wherein said nozzle means are in the form of said nozzle means calibrated so as to cause a predetermined load loss of said first reagent, in particular in the liquid phase, especially in the form of an organic raw material, feeding towards the respective, in particular elongated and/or tubular, reaction chamber, and such as to ensure a controlled, in particular a constant or substantially constant, flow rate, of said first reagent, in particular in the liquid phase, especially in the form of an organic raw material, entering the respective, in particular elongated and/or tubular, reaction chamber, and so as to evenly distribute said first reagent, in particular in the liquid phase, especially in the form of an organic raw material, on the respective inner surface thereof.

51. The reactor according to claim 50, wherein said nozzle means impart to said first reagent, in particular in the liquid phase, especially in the form of an organic raw material, a load loss above 5000 Pa, preferably above 10000 Pa, and more preferably above 20000 Pa.

52. The reactor according to claim 50, wherein said nozzle means comprise a single calibrated passage nozzle obtained in said means, or head, for the inlet of said first reagent, in particular in the liquid phase, especially in the form of an organic raw material, in the respective, in particular elongated and/or tubular, reaction chamber.

53. The reactor according to claim 50, wherein the calibrated passage nozzle, in particular the single calibrated passage nozzle has a respective diameter that ranges between 0.1 mm and 5 mm, and preferably that ranges between 1.2 mm and 1.6 mm.

54. The reactor according to claim 50, wherein the calibrated passage nozzle, in particular the single calibrated passage nozzle has a length that ranges between 1 mm and 30 mm and preferably that ranges between 7 mm and 10 mm.

55. The reactor according to claim 50, wherein said means, or head, for the inlet of said first reagent, in particular in the liquid phase, especially in the form of an organic raw material, in the respective, in particular elongated and/or tubular, reaction chamber, comprise an annular, in particular circumferential, cavity, for the peripheral diffusion of said first reagent, in particular in the liquid phase, especially in the form of an organic raw material, which annular, in particular circumferential, cavity for the peripheral diffusion of said first reagent, in particular in the liquid phase, especially in the form of an organic raw material, is in communication with the inside of the respective, in particular elongated and/or tubular, reaction chamber through an annular conduit that is longitudinally extending and coaxial with the respective reaction chamber, in particular radially converging towards and into the respective reaction chamber, and opening at the inner surface of the respective reaction chamber.

56. The reactor according to claim 55, wherein said annular conduit and/or said annular, in particular circumferential, cavity, for the peripheral diffusion of said first reagent, in particular in the liquid phase, especially in the form of an organic raw material, are defined between a first and a second bodies coaxially coupled one inside the other; said first body, or male body, being in connection with and coaxial to the respective, in particular elongated and/or tubular, reaction chamber and being internally hollow, in particular being tubular, to convey said second reagent, in particular in the form of a gaseous reagent, preferably in the form of sulphuric anhydride, downstream into the respective, in particular elongated and/or tubular, reaction chamber.

57. The reactor according to claim 56, wherein said nozzle means, or said calibrated passage nozzle, being provided, or provided for, in said second body, or female body, of the means, or head, for the inlet of said first reagent, in particular in the liquid phase, especially in the form of an organic raw material, in the respective, in particular elongated and/or tubular, reaction chamber.

58. The reactor according to claim 50, wherein said means for the introduction of said first reagent, in particular in the liquid phase, especially in the form of an organic raw material, into said chambers, in particular elongated and/or tubular, reaction chambers, comprise means for the distribution of said first reagent, in particular in the liquid phase, especially in the form of an organic raw material, between said reaction chambers.

59. The reactor according to claim 58, wherein said means for the distribution of said first reagent, in particular in the liquid phase, especially in the form of an organic raw material, between said chambers, in particular elongated and/or tubular, reaction chambers comprise a plane, in particular horizontal, preferably having a circular outer profile, for conveying said first reagent, in particular in the liquid phase, especially in the form of an organic raw material, towards said inlet means, or nozzle means, of the respective, in particular elongated and/or tubular, reaction chamber.

60. The reactor according to claim 59, wherein means are provided for the supplying of said first reagent, in particular in the liquid phase, especially in the form of an organic raw material, to said conveying plane of said first reagent towards said inlet means, or nozzle means, of the respective, in particular elongated and/or tubular, reaction chamber.

61. The reactor according to claim 60, wherein said means for the supplying of said first reagent, in particular in the liquid phase, especially in the form of an organic raw material, to said conveying plane, extend peripherally outwards to said conveying plane of said first reagent towards said inlet means, or nozzle means, of the respective, in particular elongated and/or tubular, reaction chamber.

62. The reactor according to claim 58, wherein said means for the peripheral supplying of said first reagent, in particular in the liquid phase, especially in the form of an organic raw material, to said conveying plane comprise a peripheral channel, in particular external to said conveying plane, and inside which said first reagent, in particular in the liquid phase, especially in the form of an organic raw material, spreads and from which it peripherally opens to said conveying plane of said first reagent towards said inlet means, or nozzle means, of the respective, in particular elongated and/or tubular, reaction chamber.

63. The reactor according to claim 62, wherein said peripheral supplying channel, in particular external to said conveying plane, and preferably circular, comprises a bottom surface, in particular horizontal, especially extending with a circular profile.

64. The reactor according to claim 58, wherein said peripheral supplying channel, in particular external to said conveying plane, and preferably circular, comprises a respective side surface, in particular circular, preferably perpendicular to said conveying plane of said first reagent and opening thereinto, and especially extending vertically, or perpendicularly, to said bottom surface, on the radially inner side thereof.

65. The reactor according to claim 58, wherein said plane for conveying said first reagent is arranged at a height level that is higher or lower than the bottom surface of said peripheral channel.

66. The reactor according to claim 50, wherein said means for inputting said second reagent, in particular in the gaseous phase, especially in the form of sulphuric anhydride, are supported by said reactor body, or outer shell, i.e., by the respective peripheral outer, in particular circumferential, wall, thereof, especially at the respective upstream, in particular upper, end thereof.

67. The reactor according to claim 66, wherein said means for inputting the second reagent, in particular in the form of a gaseous reagent, preferably in the form of sulphuric anhydride, into the same plurality of reaction chambers, in particular elongated and/or tubular, comprise a tubular, in particular cylindrical, conduit, which extends according to a respective longitudinal axis and which directly supplies the same second reagent in inlet into said reaction chambers, which tubular, in particular cylindrical, conduit has an inner, especially smooth, preferably cylindrical tubular, surface which extends according to a respective longitudinal axis parallel to the axis of said reaction chambers, i.e., coincident with the axis of said peripheral, in particular circumferential, outer wall.

68. The reactor according to claim 50, wherein means for cooling said, in particular elongated and/or tubular, reaction chambers are provided, which employ a cooling fluid, or liquid, in particular water.

69. The reactor according to claim 68, wherein said means for conveying, or diverting, the flow of said cooling fluid, or liquid, in particular in the form of water, onto, or along, the outer surface of said, in particular elongated and/or tubular, reaction chambers, comprise respective septum means, which are adapted to convey, or divert, said flow of said cooling fluid, or liquid, according to a respective predetermined path.
